(19) United States
(12) Patent Application Publication
(10) Pub. No.: US 2012/0296983 A1
(43) Pub. Date: Nov. 22, 2012

(54) MANAGING COMPRESSION DICTIONARIES

(75) Inventor: Joshua Adam Alpern Boehm, Redmond, WA (US)

(73) Assignee: Microsoft Corporation, Redmond, WA (US)

(21) Appl. No.: 13/109,698

(22) Filed: May 17, 2011

(51) Int. Cl. G06F 15/16

(52) U.S. Cl. 709/206

(57) ABSTRACT

One or more techniques and/or systems are provided for managing compression dictionaries. In particular, messages between a sender and a recipient may be compressed using a combination of static compression dictionaries and/or dynamic dictionaries. The static compression dictionaries may be updated with new dictionary entries based upon a recipient decompressing a compressed message received from a sender, a dynamic dictionary associated with the compressed message and/or a prepared response. In this way, the static dictionary may evolve over time to provide a flexible and customized approach for managing compression dictionaries. Dictionary versioning may be provided, such that a sender dictionary and a recipient dictionary may be updated to maintain synchronization.

### BACKGROUND

Communication between a sender and a recipient may often comprise redundant content. For example, communication between a client and a server may result in frequent transmissions comprising redundant data blocks, such as repeated character strings. In one example, redundancy may manifest in a single transmission comprising a data block repeated multiple times within the transmission. In another example, a data block may be frequently repeated within multiple transmissions. Thus, it may be advantageous to compress such communication using compression dictionaries. A compression dictionary may comprise dictionary entries that map data blocks to references. Because the references may be shorter in length than the data blocks, the sender may compress a message by replacing frequently used data blocks with corresponding references as specified within the compression dictionary (e.g., a character string “hardware” may be replaced with a reference “0”). A recipient of the compressed message may use the compression dictionary to decompress the compressed message. In this way, the transmission of the compressed message may reduce network bandwidth due to the smaller compressed messages. Unfortunately, it may be difficult to predict what data blocks may be repeated in advance in order to create a static predefined dictionary agreed upon by the sender and recipient before transmission. Additionally, building a dynamic dictionary specific to a particular message on the fly may have a high computational cost and may have little to no applicability to subsequent communications.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for managing compression dictionaries are disclosed herein. A compression dictionary may comprise one or more dictionary entries mapping data blocks (e.g., a string, a word, a data segment, etc.) to corresponding references (e.g., tokens, marker, etc.). In one example of a compression dictionary, the compression dictionary (e.g., a static dictionary) may be a predefined dictionary agreed upon between a sender and a recipient before transmission. In another example of a compression dictionary, the compression dictionary (e.g., a dynamic dictionary) may be a dictionary created on the fly by a sender for a particular message, which may be sent with a compressed message to the recipient for decompression. Generally, dynamic dictionaries are associated with a single message, and are not retained for further transmissions.

Accordingly, as provided herein, a compressed message may be received from a sender. The compressed message may indicate that the sender used a first dictionary version of a sender dictionary to compress the compressed message. The recipient may decompress the compressed message utilizing a recipient dictionary corresponding to the first dictionary version (e.g., the sender and recipient may maintain the sender dictionary and the recipient dictionary respectively, such that a particular version of the sender dictionary may be similar to the corresponding version of the recipient dictionary). In one example, the compressed message may have also been compressed utilizing a dynamic dictionary. In this way, the recipient may receive the dynamic dictionary to aid in decompressing the compressed message. A response for the sender may be prepared based upon the decompressed message (e.g., the message may be a request for a file, and the prepared response may comprise the file).

A dictionary update may be determined based upon the decompressed message (or the compressed message), the dynamic dictionary, and/or the prepared response. That is, the decompressed message and/or the compressed message may be scanned by the recipient for redundant data blocks that were not already compressed by the sender using the first dictionary version and/or the dynamic dictionary. In one example of determining a dictionary update, the dictionary update may be based upon redundant data blocks occurring within the decompressed message (or the compressed message) above a predetermined threshold, such as 4 occurrences. For example, the word “virtual” may have been repeated 12 times within the decompressed message, but was not compressed by the sender. Thus the recipient may determine that it may be advantageous to update the recipient and sender dictionaries with a dictionary entry mapping “virtual” to a shorter reference “18” so that future communications with the word “virtual” may be replaced with the shorter reference “18”. In another example, the word “virtual” may have been repeated 3 times within the decompressed message, and may have been repeated multiple times within prior messages from the sender. Thus, the recipient may determine that it may be advantageous to update the recipient and sender dictionaries with a dictionary entry mapping “virtual” to the shorter reference “18”.

In another example of determining a dictionary update, the dictionary update may be based upon the dynamic dictionary, if applicable (e.g., the sender may or may not utilize a dynamic dictionary to compress the compressed message). The sender may have created the dynamic dictionary on the fly for the compressed message. For example, the sender may determine that the word “flexibility” occurs 20 times within the message, but is not within the sender dictionary. Thus, the sender may create a dynamic dictionary with a dictionary entry mapping the word “flexibility” to the reference “8”. In this way, the compressed message may comprise the reference “8” in place of the word “flexibility”, along with a dynamic dictionary mapping “flexibility” to “8”. The recipient may determine that it may advantageous to update the sender and recipient dictionaries with one or more dictionary entries within the dynamic dictionary so that the sender is not re-creating similar dictionary entries in dynamic dictionaries for future messages (e.g., currently, dynamic dictionaries are specific to a particular message, and may not be retained for future messages). In this way, the sender and recipient dictionaries may be updated based upon the dynamic dictionary so that future messages comprising data blocks corresponding to the updated dictionary entries may be directly compressed from the updated dictionaries.

In another example of determining the dictionary update, redundant data blocks within the prepared response may be used to determine the dictionary update. For example, a prepared response may comprise a file requested by the sender within the decompressed message. The requested file may comprise redundant data blocks that may not be mapped to references within the sender and recipient dictionaries. In this way, the sender and recipient dictionaries may be updated so that the response may be compressed based upon the updated dictionaries.

The recipient dictionary may be updated to a second dictionary version utilizing the dictionary update. To synchronize with the sender dictionary, an update request may be sent to the sender to update the sender dictionary to a second dictionary version utilizing the dictionary update. In this way, the recipient and sender dictionaries may be updated and/or adjusted over time based upon various factors, such as a decompressed message, a dynamic dictionary, and/or a prepared response, for example. It may be appreciated that a recipient may maintain customized recipient dictionaries for a plurality of senders (e.g., a server may maintain a plurality of recipient dictionaries separately customized for particular senders). That is, as opposed to maintaining a single large recipient dictionary, smaller highly efficient dictionaries tailored for particular senders may be maintained, which may increase bandwidth/transmission savings by mitigating unnecessary updates, for example. Additionally, if a dictionary entry of a data block occurs in a number of recipient dictionaries greater than a predetermined threshold, then a dictionary update may be created based upon the data block. In this way, the recipient may “promote” to senders that a dictionary entry for the data block may be advantageous to add to sender and recipient dictionaries that may not already comprise such dictionary entries.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of managing compression dictionaries.

FIG. 2 is a flow chart illustrating an exemplary method of managing compression dictionaries.

FIG. 3 is a component block diagram illustrating an exemplary system for managing compression dictionaries.

FIG. 4 is an illustration of an example of a sender and a recipient utilizing compression dictionaries for communication.

FIG. 5 is an illustration of an example of compressing a message utilizing a sender dictionary and a dynamic dictionary to create a compressed message.

FIG. 6 is an illustration of an example of determining a dictionary update based upon a decompressed message, a dynamic dictionary, and/or a prepared response.

FIG. 7 is an illustration of an exemplary computer-readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Compression dictionaries may be used to compress messages between a sender and a recipient. A compression dictionary may comprise dictionary entries mapping data blocks (e.g., a character string “flexibility”) to a reference (e.g., a token “3”). In this way, a message may be compressed by replacing data blocks with corresponding references. A static dictionary may be a pre-defined compression dictionary agreed upon by the sender and the recipient before transmission of compressed messages. Unfortunately, it may be difficult to predict what data blocks may be repeated over time. For example, a client may initially send messages concerning music file requests, but may later send messages concerning website access requests. In contrast, a dynamic dictionary may be created by a sender on the fly for a particular message. The sender may evaluate a message, and create dictionary entries mapping redundant data blocks found within the message with references. The sender may then compress the message using the dynamic dictionary. In one example, the sender may attach the dynamic dictionary with the compressed message so that the recipient may decompress the compressed message using the dynamic dictionary. In another example, the dynamic dictionary may be made available to the recipient without attaching the dynamic dictionary to the compressed message (e.g., the dynamic dictionary may be transmitted to the recipient separately from the compressed message). In any event, the recipient generally needs access to the dynamic dictionary before being able to read (e.g., decompress) the message. It may be appreciated that the dynamic dictionary may be specific to a particular message, and is generally not retained for future messages. Unfortunately, creating dynamic dictionaries may be computationally intensive, which may waste resources when similar dynamic dictionaries are re-created over and over for messages. Thus, it may be advantageous to leverage both fixed dictionaries and dynamic dictionaries to provide a management scheme to dynamically update dictionaries based upon various factors, such as decompressed messages, dynamic dictionaries, prepared responses, and/or a variety of other factors (e.g., dynamic dictionary entries may be retained for future compression by updating a static dictionary using the dynamic dictionary).

Accordingly, one or more systems and/or techniques for managing compression dictionaries are provided herein. In particular, a sender may maintain one or more dictionary versions of a sender dictionary, which may correspond to one or more dictionary versions of a recipient dictionary maintained by a recipient. The sender may compress a message using a sender dictionary and/or a dynamic dictionary. The recipient may decompress the compressed message using a corresponding version of the recipient dictionary and/or the dynamic dictionary. A response to the decompressed message may be prepared. A dictionary update may be determined based upon the decompressed message (or compressed response), the dynamic dictionary, and/or the prepared response. In this way, the sender and recipient dictionary may be updated using the dictionary update. Thus, the sender and recipient dictionaries may evolve over time to provide flexibility and customizability.

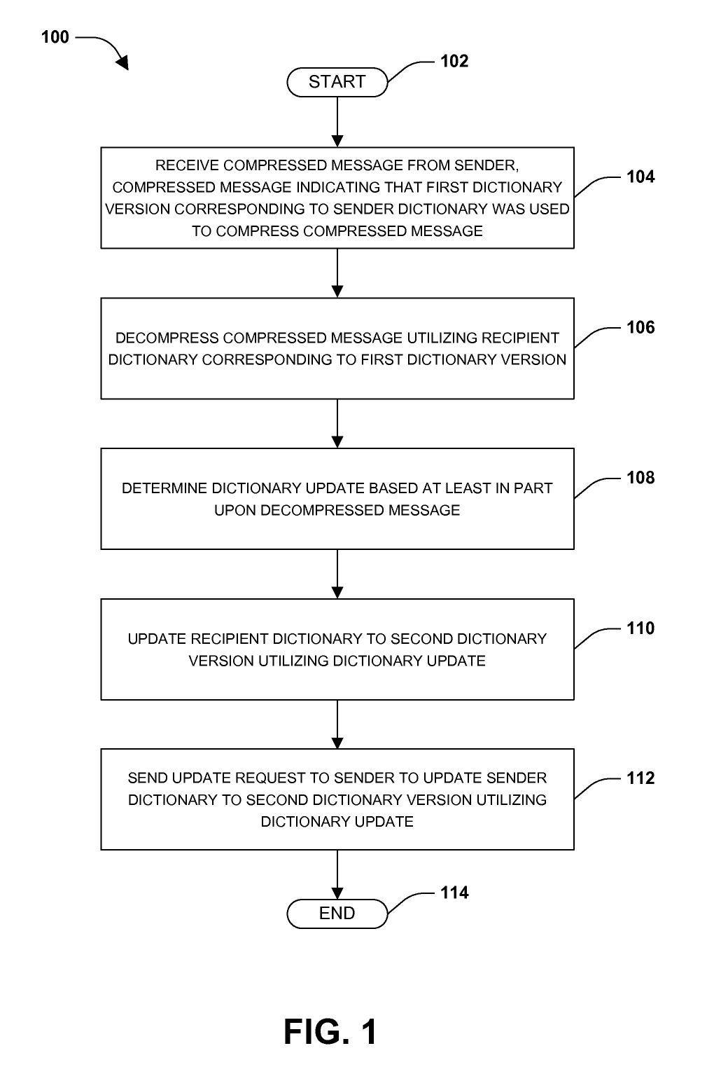

One embodiment of managing compression dictionaries is illustrated by an exemplary method 100 in FIG. 1. At 102, the method starts. At 104, a compressed message may be received from a sender. The compressed message may indicate that a first dictionary version corresponding to a sender dictionary was used to compress the compressed message. For example, the sender may maintain one or more versions of a sender dictionary, while a recipient may maintain one or more versions of a corresponding recipient dictionary. (e.g., a first dictionary version of a sender dictionary may comprise similar dictionary entries as the first dictionary version of a recipient dictionary). In one example, the sender and recipient dictionaries may be compression dictionaries comprising mappings of data blocks to corresponding references. As such, the message may be compressed by replacing data blocks within the message with corresponding references as defined by the sender dictionary.

In one example, a dynamic dictionary associated with the compressed message may be received. The dynamic dictionary may be a compression dictionary created on the fly by the sender based upon the compressed message. That is, the sender may initially compress a message using the first dictionary version of the sender dictionary to create the compressed message. However, the compressed message may comprise additional redundant data blocks that are not mapped within the sender dictionary. Thus, the compressed message may be further compressed by the sender by scanning the compressed message for redundant data blocks. The sender may build the dynamic dictionary for the compressed message by creating dictionary entries mapping the redundant data blocks to corresponding references. Once built, the compressed message may be further compressed using the dynamic dictionary by replacing the redundant data blocks with the corresponding references as specified within the dynamic dictionary. It may be appreciated that in one example, computational overhead associated with scanning for redundant data blocks when creating the dynamic dictionary may be reduced because the compressed message is scanned, as opposed to the larger original message. In this way, the compressed message may be compressed with the sender dictionary and/or the dynamic dictionary to provide flexibility and customizability by using predefined dictionary entries (sender dictionary) and/or custom dictionary entries tailored for the current message (dynamic dictionary).

At 106, the compressed message may be decompressed utilizing a recipient dictionary corresponding to the first dictionary version. That is, the recipient may use the recipient dictionary to replace references within the compressed message with corresponding data blocks. If the compressed message is associated with a dynamic dictionary, then the recipient may utilize the dynamic dictionary to decompress the message by replacing data blocks within the compressed message with corresponding references.

In one example, the recipient may prepare a response for the sender based upon the decompressed message. For example, the decompressed message may indicate that the sender requests a text document. The recipient may retrieve the text document in preparation for a response to the sender. Thus, the prepared response may comprise the text document.

At 108, a dictionary update may be determined based at least in part upon the decompressed message (or the compressed message). It may be appreciated that the dictionary update may be based upon a variety of factors, such as the prepared response, the dynamic dictionary, and/or other factors. In one example of determining the dictionary update, the dictionary update may be based upon redundant data blocks occurring within the decompressed message (or compressed message) that were not already compressed by the sender using the sender dictionary and/or the dynamic dictionary. For example, the word “flexibility” may occur 8 times within the decompressed message, but was not compressed by the sender, which may indicate that it may be advantageous to create a dictionary entry for the word “flexibility”.

In another example of determining the dictionary update, the dictionary update may be based upon the dynamic dictionary, if applicable. The recipient may determine that the dynamic dictionary comprises dictionary entries that may be advantageous to retain for future messages, otherwise such dictionary entries may be lost because the dynamic dictionary is specific to the compressed message and is generally not retained. Accordingly, dictionary entries within the dynamic dictionary may be used to determine the dictionary update so that the recipient and sender dictionaries may be updated with such dictionary entries for future message transmissions. In this way, the sender and/or the recipient may compress messages/responses using the updated dictionaries (e.g., a second version of a dictionary updated from a first version of the dictionary) without having to create dynamic dictionaries for the updated dictionary entries.

In another example of determining the dictionary update, the dictionary update may be based upon the prepared response. For example, the decompressed message may request a text document from the recipient. A response comprising the requested text document may be prepared. The text document may be scanned for redundant data blocks that may not already be mapped to corresponding references within the sender and recipient dictionaries. In this way, the sender and recipient dictionaries may be updated so that the response and/or future communication may be compressed based upon the updated dictionaries.

At 110, the recipient dictionary may be updated to a second dictionary version utilizing the dictionary update. In this way, the second dictionary version may comprise updated dictionary entries derived from the decompressed message, the dynamic dictionary, and/or the prepared response. In one example, the second dictionary version may comprise one or more dictionary entries from the first dictionary version (e.g., the second dictionary version may comprise dictionary entries from the first dictionary version, along with updated dictionary entries from the dictionary update). At 112, an update request may be sent to the sender to update the sender dictionary to the second dictionary version utilizing the dictionary update. For example, the update request may comprise the dictionary update, such as a difference in dictionary entries between the first dictionary version and the second dictionary version. Updating the sender dictionary to the second dictionary version may synchronize the sender dictionary with the second dictionary version of the recipient dictionary so that the sender and recipient may utilize the second dictionary version for compressing future communication.

The prepared response may be compressed using the second dictionary version. The recipient may send the compressed response to the sender. The sender may decompress the compressed response using the second dictionary version of the sender dictionary, which may have been updated to the second dictionary version based upon the update request. It may be appreciated that future communication between the sender and the recipient may be compressed using the second dictionary version. For example, the recipient may receive a second compressed message from the sender. The second compressed message may indicate that the second dictionary version was used to compress the second compressed message. The recipient may decompress the second compressed message utilizing the second dictionary version of the recipient dictionary.

In one example, the recipient may be configured as a server that communications with a plurality of senders configured as clients. The server may comprise client dictionaries (e.g., recipient dictionaries) customized for particular clients (e.g., the server may comprise one or more dictionary versions of a first client dictionary corresponding to a first client, one or more dictionary versions of a second client dictionary corresponding to a second client, and/or other client dictionaries respectively customized for various clients). In this way, the server may maintain a collection of client dictionaries for compressing/decompressing messages with corresponding clients. Dictionary entries across various client dictionaries may be leveraged to determine whether it may be advantageous to add frequently occurring dictionary entries into other client dictionaries that may not already comprise such dictionary entries (e.g., a dictionary entry for the data block “populate” may occur within 30 out of 45 client dictionaries, such that it may be advantageous to update the 15 other client dictionaries with the dictionary entry for “populate”). Additionally, maintaining separate client dictionaries for respective clients may reduce the size of dictionaries and/or the frequency at which dictionaries are updated. At 114, the method ends.

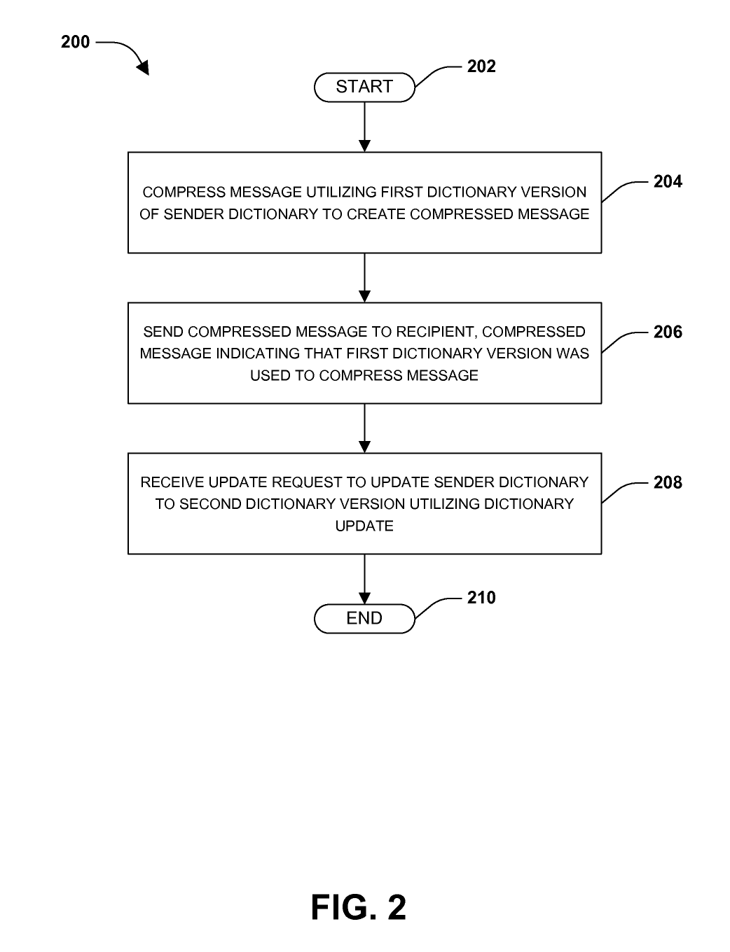

One embodiment of managing compression dictionaries is illustrated by an exemplary method 200 in FIG. 2. At 202, the method starts. At 204, a message may be compressed utilizing a first dictionary version of a sender dictionary to create a compressed message. The sender dictionary may comprise dictionary entries mapping data blocks to references. In one example of compressing the message, the message may be scanned for data blocks mapped within dictionary entries within the sender dictionary. The sender may replace such data blocks with corresponding references as defined by the first dictionary version. In another example of compressing the message, the message may be compressed utilizing a dynamic dictionary. That is, the message (or the compressed message that was compressed using the sender dictionary) may be scanned for redundant data blocks. The redundant data blocks may be used to build a dynamic dictionary comprising dictionary entries mapping the data blocks to corresponding references. In this way, the dynamic dictionary may be used to replace the redundant data blocks with the corresponding references. The dynamic dictionary may be sent to the recipient to aid in decompressing the compressed message (e.g., the dynamic dictionary may be incorporated into the compressed message). At 206, the compressed message may be sent to the recipient. The compressed message may indicate that the first dictionary version and/or the dynamic dictionary was used to compress the message.

At 208, an update request to update the sender dictionary to a second dictionary version utilizing a dictionary update may be received, for example from the recipient of the compressed message. For example, the recipient may have determined that one or more dictionary entries (e.g., mappings of data blocks to references) may be advantageous to add to the sender and recipient dictionaries. The recipient may have created the dictionary update based upon decompressing the compressed message, the dynamic dictionary, a prepared response, and/or other factors. As such, the recipient may have updated a recipient dictionary to a second dictionary version using the dictionary update. The recipient may have compressed a response for the sender using the second dictionary version. In this way, the sender may update the sender dictionary to the second dictionary version using the dictionary update. The sender may receive a compressed response that was compressed by the recipient using the second dictionary version (an updated recipient dictionary). The sender may decompress the compressed response using the second dictionary version (the updated sender dictionary).

In one example, a second message may be compressed utilizing the second dictionary version to create a second compressed message. The second compressed message may be sent to the recipient. The second compressed message may indicate that the second dictionary version (the updated sender dictionary) was used to compress the second message. In this way, the recipient may decompress the second compressed message using the second dictionary version (the updated recipient dictionary). At 210, the method ends.

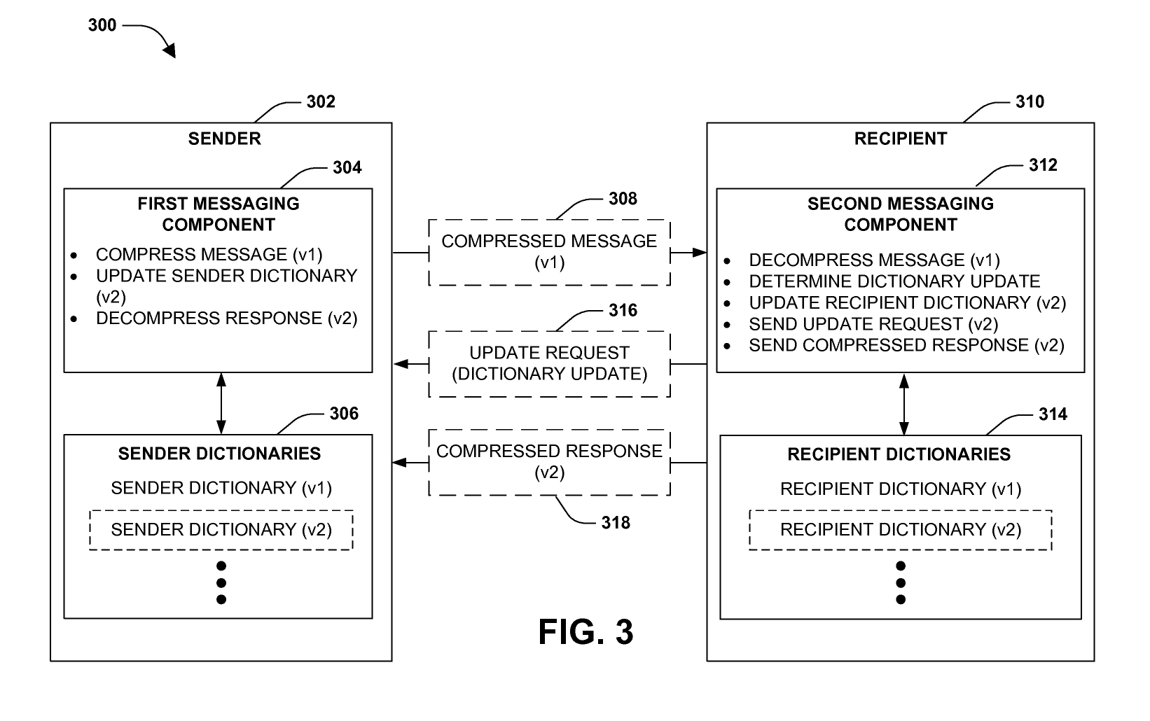

FIG. 3 illustrates an example of a system 300 configured for managing compression dictionaries. The system 300 may comprise a messaging component (e.g., a first messaging component 304 of sender 302 and/or a second messaging component 312 of recipient 310). The first messaging component 304 of sender 302 may be configured to manage one or more sender dictionaries 306 (e.g., a first dictionary version of a sender dictionary, a second dictionary version of the sender dictionary, and/or other dictionary versions of the sender dictionary). The first messaging component 304 may be configured to compress a message utilizing one of the sender dictionaries 306. For example, the first messaging component 304 may compress a messaging utilizing the first dictionary version of the sender dictionary. That is, the first messaging component 304 may replace data blocks within the message with corresponding references as defined by the first dictionary version. In one example, the first messaging component 304 may create a dynamic dictionary for the compressed message by scanning the compressed message for additional redundant data blocks that were not already compressed. The first messaging component 304 may compress the compressed message using the dynamic dictionary. The first messaging component 304 may send 308 the compressed message to the recipient 310, along with an indication that the first dictionary version was used to compress the compressed message. If the first messaging component 304 compressed the compressed message using a dynamic dictionary, then the first messaging component 304 may send the dynamic dictionary to the recipient 310.

The second messaging component 312 of the recipient 310 may be configured to manage one or more recipient dictionaries 314 (e.g., a first dictionary version of a recipient dictionary, a second dictionary version of a recipient dictionary, and/or other dictionary versions of the recipient dictionary). The recipient dictionaries 314 may correspond to the sender dictionaries 306. It may be appreciated that the recipient 310 may interact with a plurality of senders, and thus the second messaging component 312 may maintain separate collections of recipient dictionaries corresponding to the respective senders. Similarly, the sender 302 may interact with a plurality of recipients, and thus the first messaging component 304 may maintain separate collections of sender dictionaries corresponding to the respective recipients.

The second messaging component 312 may be configured to receive the compressed message. The second messaging component 312 may decompress the compressed message utilizing a recipient dictionary corresponding to the first dictionary version. If the second messaging component 312 received a dynamic dictionary, then the second messaging component 312 may decompress the compressed message utilizing the dynamic dictionary. It may be appreciated that in one example, the compressed message may be decompressed using the dynamic dictionary and/or a recipient dictionary version corresponding to the compressed message. The second messaging component 312 may prepare a response for the sender 302 based upon the decompressed message.

The second messaging component 312 may determine a dictionary update based upon the decompressed message (or compressed message), the dynamic dictionary, and/or the prepared response. The second messaging component 312 may update the recipient dictionary (recipient dictionary version 1) to a second dictionary version (recipient dictionary version 2) utilizing the dictionary update. The second messaging component 312 may send 316 an update request to the sender 302 to update the sender dictionary (sender dictionary version 1) to the second dictionary version (sender dictionary version 2) utilizing the dictionary update. Additionally, the second messaging component 312 may compress the prepared response utilizing the second dictionary version (recipient dictionary version 2). The second messaging component 312 may send 318 the compressed response to the sender 302.

The first messaging component 304 of the sender 302 may be configured to update the sender dictionary (sender dictionary version 1) to the second dictionary version (sender dictionary version 2) based upon the update request (e.g., the dictionary update may be used to update the sender dictionary version 1 to a sender dictionary version 2). The first messaging component 304 may decompress the compressed response using the second dictionary version (sender dictionary version 2).

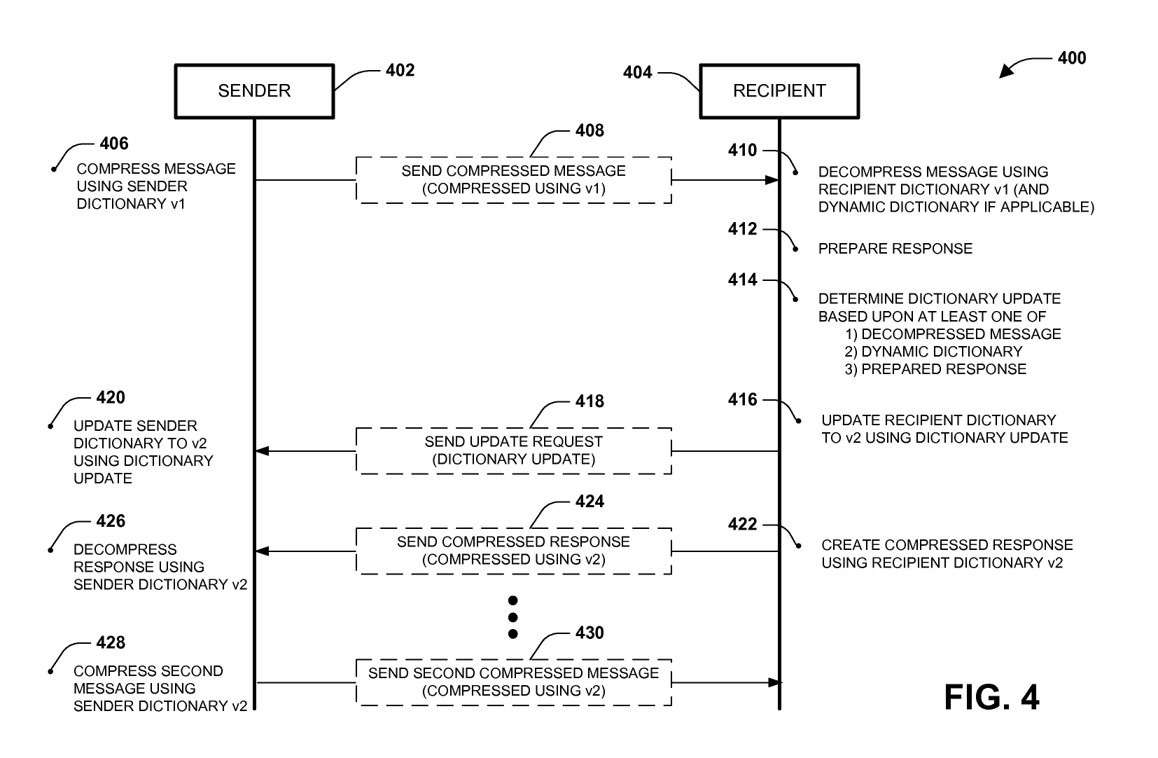

FIG. 4 illustrates an example 400 of a sender 402 and a recipient 404 utilizing compression dictionaries for communication. The sender 402 may compress 406 a message utilizing a first dictionary version of a sender dictionary. Additionally, the sender 402 may create a dynamic dictionary, and may compress the compressed message using the dynamic dictionary. The sender 402 may send 408 the compressed message to the recipient 404, along with an indication that the first dictionary version was used for compression. If the sender 402 compressed the compressed message using the dynamic dictionary, then the sender 402 may send the dynamic dictionary to the recipient 404. The recipient 404 may decompress 410 the compressed message using a recipient dictionary corresponding to the first dictionary version. If the compressed message was compressed using the dynamic dictionary, then the recipient 404 may decompress the compressed message using the dynamic dictionary. The recipient 404 may prepare 412 a response based upon the decompressed message.

The recipient 404 may determine 414 a dictionary update based upon the decompressed message (or compressed message), the dynamic dictionary, and/or the prepared response. The recipient 404 may update 416 the recipient dictionary using the dictionary update to create a second dictionary version. The recipient 404 may send 418 an update request (e.g., a request comprising the dictionary update) to the sender 402. The sender 402 may update 420 the sender dictionary to the second dictionary version using the dictionary update.

The recipient 404 may create 422 a compressed response using the second dictionary version of the recipient dictionary. The recipient 404 may send 424 the compressed response to the sender 402. The sender 402 may decompress 426 the compressed response using the second dictionary version of the sender dictionary.

It may be appreciated that the sender 402 and recipient 404 may utilize the second dictionary version for future communication. In one example, the sender 402 may compress 428 a second message using the second dictionary version of the sender dictionary to create a second compressed message. The sender 402 may send 430 the second compressed message to the recipient, along with an indication that the second compressed message was compressed with the second dictionary version. The recipient 404 may decompress the second compressed message using the second dictionary version of the recipient dictionary.

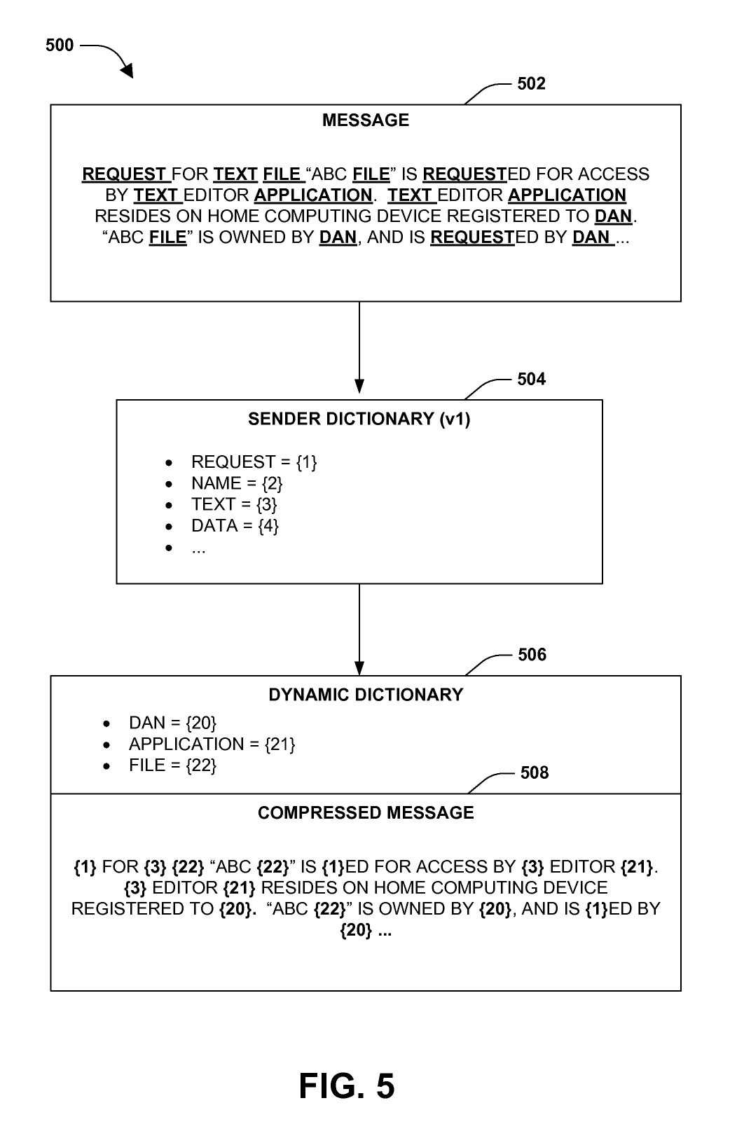

FIG. 5 illustrates an example 500 of compressing a message 502 utilizing a sender dictionary 504 and a dynamic dictionary 506 to create a compressed message 508. A sender may maintain a first dictionary version of the sender dictionary 504. The sender dictionary 504 may comprise dictionary entries mapping data blocks to references. For example, a data block “request” may be mapped to a reference “1”, a data block “name” may be mapped to a reference “2”, a data block “text” may be mapped to a reference “3”, a data block “data” may be mapped to a reference “4”, and/or other data blocks may be mapped to corresponding references. The sender may compress the message 502 utilizing the sender dictionary 504 by replacing data blocks with corresponding references. For example, three occurrences of the data block “request” may be replaced with the reference “1”; three occurrences of the data block “text” may be replaced with the reference “3”; etc.

Additionally, the sender may scan the message 502 (or a compressed version of the message that was compressed using the sender dictionary 504) for additional redundant data blocks to build the dynamic dictionary 506. For example, a data block “dan” occurs three times, a data block “application” occurs two times, and a data block “file” occurs three times within message 502. The sender may build the dynamic dictionary by mapping the data blocks “dan”, “application”, and “file” to references “20”, “21”, and “22” respectively. It may be appreciated that in one example, the dynamic dictionary may be specific to message 502. The sender may compress the message 502 (or the compressed version of the message that was compressed using the sender dictionary 504) to create the compressed message 508. For example, data block “dan” may be replaced with reference “20”, data block “application” may be replaced with reference “21”, and data block “file” may be replaced with reference “22”, which may supplement the compression performed using the sender dictionary 504. The sender may send the compressed message 508 and/or the dynamic dictionary 506 to the recipient.

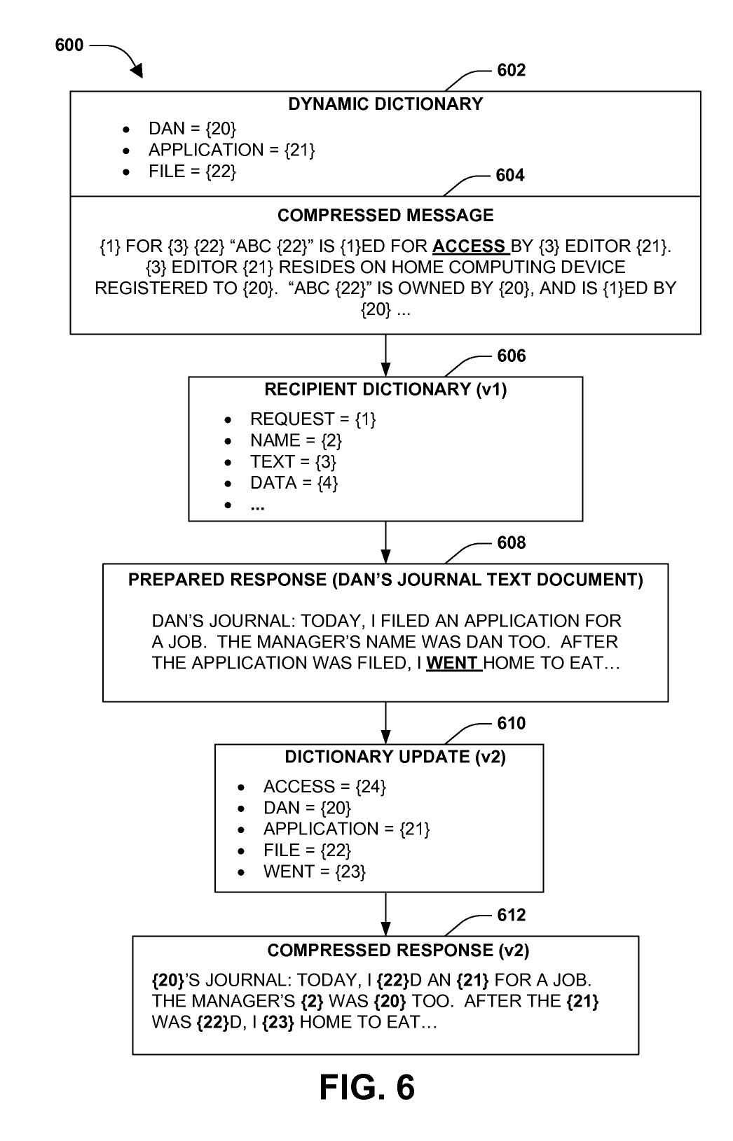

FIG. 6 illustrates an example 600 of determining a dictionary update 610 based upon a decompressed message (or a compressed message 604), a dynamic dictionary 602, and/or a prepared response 608. The compressed message 604 and the dynamic dictionary 602 may be received by a recipient. The compressed message 604 may have been compressed by a sender utilizing a first dictionary version of a sender dictionary (e.g., a first dictionary version of the sender dictionary corresponding to a first dictionary version of a recipient dictionary) and/or the dynamic dictionary 602. The recipient may decompress the compressed message 604 using a first dictionary version of a recipient dictionary 606 and/or the dynamic dictionary 602 to create a decompressed message. The recipient may prepare a response (e.g., a prepared response 608) based upon the decompressed message. For example, the decompressed message may request Dan's journal text document. As such, the prepared response 608 may comprise Dan's journal text document.

The recipient may determine a dictionary update 610 based upon the decompressed message (or the compressed message 604), the dynamic dictionary 602, and/or the prepared response 608. In one example of determining the dictionary update 610, the recipient may scan the decompressed message (or the compressed message 604) for redundant data blocks that were not already compressed by the sender within the compressed message 604. For example, the data block “access” may occur within the decompressed message (or the compressed message 604) above a predetermined threshold number of times (e.g., more than 4 occurrences). Thus, the recipient may determine that it may be advantageous to create a dictionary entry for data block “access” within the dictionary update 610 because the data block “access” has occurred above a predetermined threshold and/or the data block “access” has not yet been mapped to a reference within the sender and recipient dictionaries. In this way, the dictionary update 610 may comprise a dictionary entry mapping data block “access” to reference “24”.

The dictionary update 610 may be determined based upon the dynamic dictionary 602. For example, the dictionary update 610 may comprise a dictionary entry mapping data block “dan” to reference “20”, a dictionary entry mapping data block “application” to reference “21”, and data block “file” to reference “22” as defined by the dynamic dictionary 602.

The dictionary update 610 may be determined based upon the prepared response 608. In particular, the prepared response 608 Dan's journal text document may be scanned for redundant data blocks (e.g., data blocks occurring above a predetermined threshold), which may be used to create dictionary entries within the dictionary update 610. For example, the data block “went” may occur within the prepared response 608 above a predetermined threshold number of times (e.g., more than 4 occurrences). Thus, the recipient may determine that it may be advantageous to create a dictionary entry for data block “went” within the dictionary update 610 because the data block “went” has occurred above the predetermined threshold and/or the data block “went” has not yet been mapped to a reference within the sender and recipient dictionaries. In this way, the dictionary update 610 may comprise a dictionary entry mapping data block “went” to reference “23”.

The dictionary update 610 may be used to update the recipient dictionary 606 to a second dictionary version not illustrated. For example, the second dictionary version may comprise the original dictionary entries of the first dictionary version, along with the dictionary entries specified within the dictionary update 610. An update request may be sent to the sender so that the sender may update the sender dictionary to the second dictionary version. In this way, the sender and recipient dictionaries may be synchronized based upon the second dictionary version. The recipient may compress the prepared response 608 using the second dictionary version to create the compressed response 612. For example, data block “dan” may be replaced with the reference “20”, data block “application” may be replaced with the reference “21”, data block “name” may be replaced with the reference “2”, data block “file” may be replaced with the reference “22”, and data block “went” may be replaced with the reference “23”. The compressed response 612 may be sent to the sender. The sender may decompress the compressed response 612 using the second dictionary version.

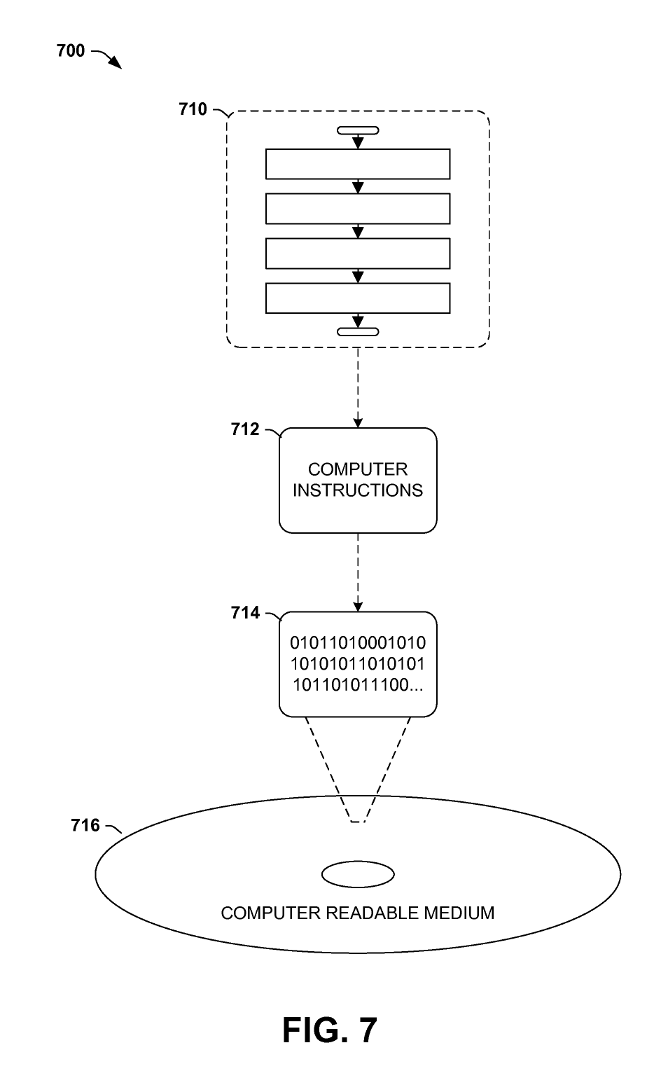

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 716 (e.g., a CD-R, DVD-R, or a platter of a hard disk drive), on which is encoded computer-readable data 714. This computer-readable data 714 in turn comprises a set of computer instructions 712 configured to operate according to one or more of the principles set forth herein. In one such embodiment 700, the processor-executable computer instructions 712 may be configured to perform a method 710, such as at least some of the exemplary method 100 of FIG. 1 and/or exemplary method 200 of FIG. 2, for example. In another such embodiment, the processor-executable instructions 712 may be configured to implement a system, such as at least some of the exemplary system 300 of FIG. 3, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

It may be appreciated that at least one of A and B and/or the like generally means A or B or both A and B.

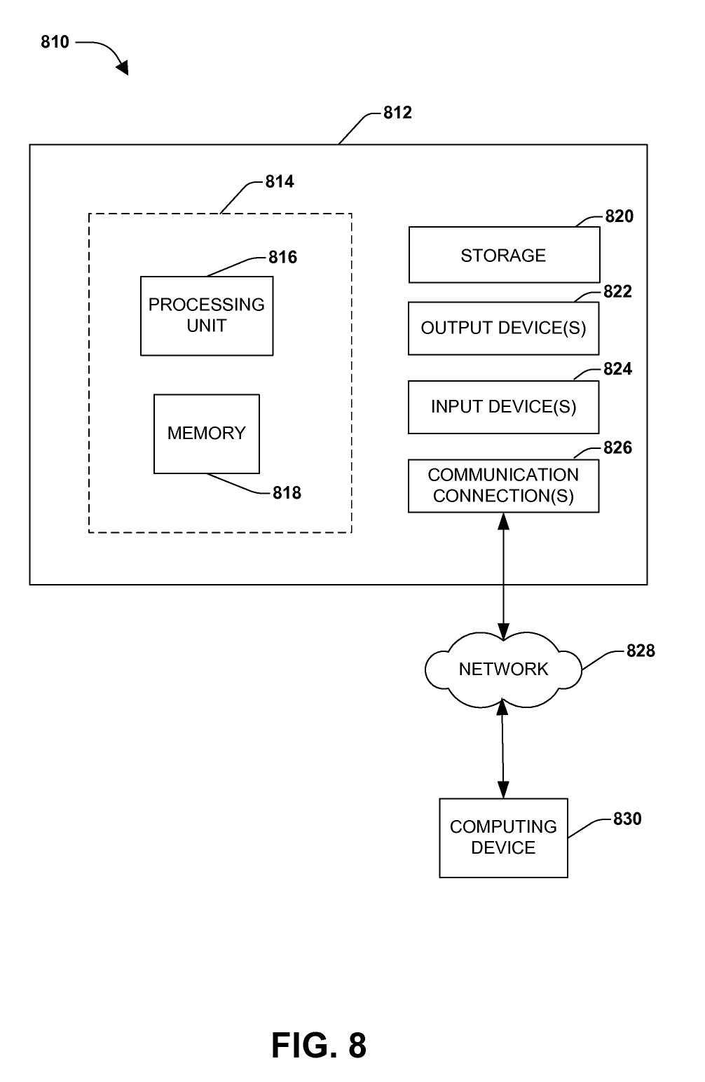

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1384), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for managing compression dictionaries, comprising:
receiving a compressed message from a sender, the compressed message indicating that a first dictionary version corresponding to a sender dictionary was used to compress the compressed message;
decompressing the compressed message utilizing a recipient dictionary corresponding to the first dictionary version;
determining a dictionary update based at least in part upon the decompressed message;
updating the recipient dictionary to a second dictionary version utilizing the dictionary update; and
sending an update request to the sender to update the sender dictionary to the second dictionary version utilizing the dictionary update.

2. The method of claim 1, comprising:
receiving a dynamic dictionary associated with the compressed message, the compressed message compressed utilizing the dynamic dictionary; and
decompressing the compressed message utilizing the dynamic dictionary.

3. The method of claim 2, the determining a dictionary update comprising:
determining the dictionary update based at least in part upon the dynamic dictionary.

4. The method of claim 1, comprising:
managing a plurality of recipient dictionaries associated with corresponding senders; and
determining the dictionary update based upon a dictionary entry occurring in a number of recipient dictionaries greater than a predetermined threshold.

5. The method of claim 1, the sender dictionary and the recipient dictionary comprising one or more dictionary entries, a dictionary entry mapping a data block to a reference.

6. The method of claim 1, the compressed message comprising one or more data blocks replaced with corresponding references.

7. The method of claim 1, comprising:
sending a compressed response to the sender, the compressed response compressed utilizing the second dictionary version.

8. The method of claim 7, comprising:
receiving a second compressed message from the sender, the second compressed message indicating that the second dictionary version was used to compress the second compressed message; and
decompressing the second compressed message utilizing the second dictionary version.

9. The method of claim 1, comprising:
preparing a response for the sender based upon the decompressed message; and
determining the dictionary update based at least in part upon the prepared response.

10. The method of claim 9, comprising:
creating a compressed response based upon compressing the prepared response using the second dictionary version.

11. A method for managing compression dictionaries, comprising:
compressing a message utilizing a first dictionary version of a sender dictionary to create a compressed message;
sending the compressed message to a recipient, the compressed message indicating that the first dictionary version was used to compress the message; and
receiving an update request to update the sender dictionary to a second dictionary version utilizing a dictionary update.

12. The method of claim 11, comprising:
updating the sender dictionary to the second dictionary version utilizing the dictionary update.

13. The method of claim 11, comprising:
receiving a compressed response, the compressed response compressed utilizing the second dictionary version; and
decompressing the compressed response utilizing the second dictionary version.

14. The method of claim 11, comprising:
compressing the message utilizing a dynamic dictionary; and
sending the dynamic dictionary to the recipient.

15. The method of claim 14, the update request based at least in part upon the recipient decompressing the compressed message utilizing the dynamic dictionary.

16. The method of claim 12, comprising:
compressing a second message utilizing the second dictionary version to create a second compressed message; and
sending the second compressed message to the recipient, the second compressed message indicating that the second dictionary version was used to compress the second message.

17. The method of claim 11, the compressing a message comprising:
replacing one or more data blocks within the message with corresponding references as defined within the first dictionary version.

18. A system for managing compression dictionaries, comprising:
a messaging component configured to:
receive a compressed message from a sender, the compressed message indicating that a first dictionary version corresponding to a sender dictionary was used to compress the compressed message;
decompress the compressed message utilizing a recipient dictionary corresponding to the first dictionary version;
determine a dictionary update based at least in part upon the decompressed message;
update the recipient dictionary to a second dictionary version utilizing the dictionary update; and
send an update request to the sender to update the sender dictionary to the second dictionary version utilizing the dictionary update.

19. The system of claim 18, the messaging component configured to:
receive a dynamic dictionary associated with the compressed message, the compressed message compressed utilizing the dynamic dictionary; and
determine the dictionary update based at least in part upon the dynamic dictionary.

20. The system of claim 18, the messaging component configured to:
prepare a response for the sender based upon the decompressed message; and
determine the dictionary update based at least in part upon the prepared response.
